(19) United States
(12) Patent Application Publication
(10) Pub. No.: US 2026/0219125 A1
(43) Pub. Date: Jul. 30, 2026

(54) LEAK EMISSIONS SENSOR SYSTEMS AND PROCESSES FOR INSTALLING AND USING SAME

(71) Applicant: Schlumberger Technology Corporation, Sugar Land, TX (US)

(72) Inventors: Kashif RASHID, Cambridge, MA (US); Lukasz ZIELINSKI, Cambridge, MA (US); Andrew J. SPECK, Cambridge, MA (US)

(21) Appl. No.: 19/141,343

(22) PCT Filed: Jan. 19, 2024
(86) PCT No.: PCT/US2024/012087

§ 371 Date: Jun. 20, 2025

Related U.S. Application Data
(60) Provisional application No. 63/480,563, filed on Jan. 19, 2023.

(51) Int. Cl. G01M 3/16; G01D 3/10; G01D 11/30; G01D 21/02; G01S 19/14

(52) U.S. Cl. CPC G01M 3/16; G01D 3/10; G01D 11/30; G01D 21/02; G01S 19/14

(57) ABSTRACT

A leak emissions sensor system for a facility. In some embodiments, the leak emissions sensor system can include one or more detector assemblies. Each detector assembly can include a sensor assembly for obtaining and sending emission information and a displacement apparatus. The sensor assembly can include a leak emission detection sensor, a sensor processor, a GPS, a real-time clock, a wind sensor, and a sensor communicator. The sensor assembly can be disposed on the displacement apparatus. The displacement apparatus can be configured to relocate the sensor assembly within the facility.

### CROSS REFERENCE PARAGRAPH

This application claims the benefit of U.S. Provisional Application No. 63/480,563, entitled “LEAK EMISSIONS SENSOR SYSTEMS AND PROCESSES FOR INSTALLING AND USING SAME,” filed Jan. 19, 2023, the disclosure of which is hereby incorporated herein by reference.

### FIELD

Embodiments described generally relate to emission detection systems. More particularly, such embodiments relate to leak emissions sensor systems and processes for installing and using same.

### BACKGROUND

Fixed sensors can provide precision data at fixed locations with known locations in order to determine emission leaks from chemical spills, gas plumes, and the like at a facility. However, a multitude of fixed sensors can be required to cover the entire facility in order to effectively detect an emission leak at the facility. Furthermore, prevailing winds and other atmospheric conditions can create uncertainty and variability in the detection ability of fixed sensors. As a result, fixed sensors can fail to pinpoint the source of emission leaks with significant accuracy. Furthermore, fixed sensors can fail to pinpoint the source of emission leaks in real-time as detection variability is processed and adjusted.

There is a need, therefore, for improved emission detection systems to account for both variable facility size and/or variable wind conditions in real-time.

### SUMMARY

Leak emissions sensor systems for a facility are provided. In some embodiments, the leak emissions sensor system for a facility can include one or more detector assemblies. Each detector assembly can include a sensor assembly for obtaining and sending emission information and a displacement apparatus. The sensor assembly can include a leak emission detection sensor, a sensor processor, a GPS, a real-time clock, a wind sensor, and a sensor communicator. The sensor assembly can be disposed on the displacement apparatus, and the displacement apparatus can be configured to relocate the sensor assembly within the facility.

In other embodiments, a leak emissions sensor system for a facility can include one or more detector assemblies. Each detector assembly can include a sensor assembly for obtaining and sending emission information and an airflow apparatus. The sensor assembly can include a leak emission detection sensor, a sensor processor, a GPS, a real-time clock, a wind sensor, a pump, and a sensor communicator. The sensor assembly can be in fluid communication with the airflow apparatus. The airflow apparatus can be configured to direct a gas to or about the sensor assembly using the pump.

In some embodiments, a leak emissions sensor system for a facility can include one or more detector assemblies. Each detector assembly can include a sensor assembly for obtaining and sending emission information, a sensor track, and a sail. The sensor assembly can include a leak emission detection sensor, a sensor processor, a GPS, a real-time clock, a wind sensor, and a sensor communicator. The sensor assembly can be disposed on the sensor track. The sensor track can be configured to allow the sensor assembly to freely move along the sensor track. The sail can be disposed on the sensor assembly. The sail can be configured to utilize air movement about the sensor assembly to move the sensor assembly along the sensor track.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are, therefore, not to be considered limiting of its scope, for the invention may admit to other equally effective embodiments. It is emphasized that the figures are not necessarily to scale and certain features and certain views of the figures can be shown exaggerated in scale or in schematic for clarity and/or conciseness.

FIG. 1A depicts an illustrative leak emissions sensor system that includes a sensor assembly moveable along a linear displacement apparatus for detecting an emissions leak from a source, according to one or more embodiments described.

FIG. 1B depicts an illustrative sensor assembly, according to one or more embodiments described.

FIG. 2A depicts another illustrative leak emissions sensor system that includes a sensor assembly moveable along a vertical displacement apparatus for detecting an emissions leak from a source, according to one or more embodiments described.

FIG. 2B depicts another illustrative leak emissions sensor system that includes a sensor assembly moveable along a rotational displacement apparatus for detecting an emissions leak from a source, according to one or more embodiments described.

FIG. 2C depicts another illustrative leak emissions sensor system that includes a sensor assembly moveable along a railway displacement apparatus for detecting an emissions leak from a source, according to one or more embodiments described.

FIG. 3 depicts another illustrative leak emissions sensor system that includes a fixed sensor assembly, a pump, and one or more airflow apparatus for detecting an emissions leak from a source, according to one or more embodiments described.

FIG. 4 depicts another illustrative leak emissions sensor system that includes a sensor assembly that includes a sail coupled thereto, the sensor assembly moveable along a railway sensor track for detecting an emissions leak from a source, according to one or more embodiments described.

FIG. 5 depicts another illustrative leak emissions sensor system that includes a sensor assembly that includes a sail coupled thereto, the sensor assembly moveable along a cable-car sensor track for detecting an emissions leak from a source, according to one or more embodiments described.

FIG. 6 depicts a schematic of an illustrative leak emission computing system for automating conveyance operations using a displacement apparatus, according to one or more embodiments described.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various embodiments and across the figures provided herein. This repetition is for the purpose of simplicity and clarity and does not in itself dictate a relationship between the various embodiments and/or configurations. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Furthermore, in the following discussion and in the claims, the terms “including” and “comprising” are used in an open-ended fashion, and thus should be interpreted to mean “including, but not limited to.”

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “an olefin” include embodiments where one, two, or more olefins are used, unless specified to the contrary or the context clearly indicates that only one olefin is used.

Unless otherwise indicated herein, all numerical values are “about” or “approximately” the indicated value, meaning the values take into account experimental error, machine tolerances and other variations that would be expected by a person having ordinary skill in the art. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for making the measurement.

Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions, and examples, but the inventions are not limited to these embodiments, versions or examples, which are included to enable a person having ordinary skill in the art to make and use the inventions, when the information in this disclosure is combined with publicly available information and technology.

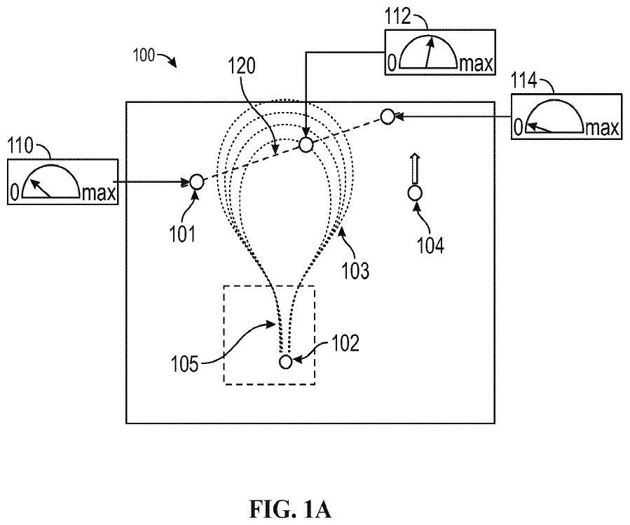

FIG. 1A depicts an illustrative leak emissions sensor system 100 that includes a sensor assembly 101 moveable along a linear displacement apparatus 120 for detecting an emissions leak, e.g., a gas plume, 103 from an emissions source 102, according to one or more embodiments. The leak emissions sensor system 100 can be located within a facility or can be located elsewhere, e.g., outside a boundary of the facility. The sensor assembly 101 can be disposed upon or attached to the displacement apparatus 120. In some embodiments, the displacement apparatus 120 can be approximately linear and configured to relocate the sensor assembly 101 within the facility. The emissions source or simply source 102 can release an emission plume 103 that can move in a direction of the wind 104. The sensor assembly 101 can be used acquire a plurality of emission measurements at a plurality of locations (three are shown, 110, 112, and 114) along the displacement apparatus 120. In some embodiments, the emission measurements can be very low 110, 114 or can be very high 112 or can be some value less than, between, or greater than the emission measurements 110, 112, 114 shown. The sensor assembly 101 can transmit the emission measurements 110, 112, 114 to a leak emission computing system (not shown) to determine by one or more processes an emission region 105. In some embodiments, the emission region 105 can be determined in real-time by the leak emission computing system using the transmitted emission measurements 110, 112, 114 received from the sensor assembly 101.

FIG. 1B depicts an illustrative sensor assembly 101, 201, 301, 401, and 501, according to one or more embodiments. In some embodiments, the sensor assembly 101, 201, 301, 401, and 501 can include at least a leak emission detection sensor 151, a sensor processor 152, a global positioning sensor (“GPS”) 153, a real-time clock 154, and a sensor communicator 155. In some embodiments, the sensor assembly 101, 201, 301, 401, and 501 can also include a pump 160. The pump 160 can be configured to draw and/or pull in air or any gaseous fluids from the surrounding environment and/or through other devices, pipes, apparatuses, or the like, or any combination thereof. In some embodiments, the sensor assembly 101, 201, 301, 401, and 501 can also include a wind sensor 170. The wind sensor 170 can be configured to detect wind speed and direction. The leak emission detection sensor 151 can be configured to detect any desired emission. In some embodiments, the emission the leak emission detection sensor 151 can be configured to detect can be or can include, but is not limited to, ammonia, hydrogen sulfide, carbon monoxide, carbon dioxide, nitrous oxide, sulfur dioxide, one or more hydrocarbons, volatile organic compounds (“VOCs”), and the like. In at least one embodiment, the emission the leak emission detection sensor 131 can be configured to detect can be or can include methane. In some embodiments, the leak emission detection sensor 151 can create a detection value for subsequent processing. The GPS 153 can be any appropriate device capable of determining a geolocation and can create a location value for subsequent processing. The real-time clock 154 can be any appropriate device capable of determining a date and/or time and can create a time value for subsequent processing. The sensor processor 152 can be configured to process the detection value by matching the detection value with a location value and a time value to create an emission event. In some embodiments, the emission event can show no detectable emission, a small detectable emission, and/or a large detectable emission at one or more locations and times throughout the facility. The sensor communicator 155 can be configured to transmit emission events to the leak emission computing system. The sensor communicator 155 can be any appropriate device for communicating digital information across a network, either wired or wirelessly, such as a network adapter, network interface controller, peripheral component interconnect, and the like.

In some embodiments, the displacement apparatus 120 can be any suitable apparatus for relocating the sensor assembly 101 throughout the facility. In some embodiments, the displacement apparatus 120 can be a linear displacement apparatus, as described with regard to FIG. 1A. In other embodiments, the displacement apparatus can be a horizontal rail, a cable-car track, a vertical rail, a rotational device, a remote drone, a tethered blimp, a glider, a Ferris wheel structure, or the like, or any combination thereof. In some embodiments, the displacement apparatus can be limited or continuous, where “limited” can describe any displacement apparatus that can be configured to relocate a sensor assembly between two or more locations within the facility, such as a linear rail with endpoints at or near the perimeter of the facility and the like, and “continuous” can describe any displacement apparatus that can be configured to relocate a sensor assembly to any location along the displacement apparatus that connects back to itself, such as a cable-car track that can circumscribe the perimeter of the facility or some location within the facility and the like.

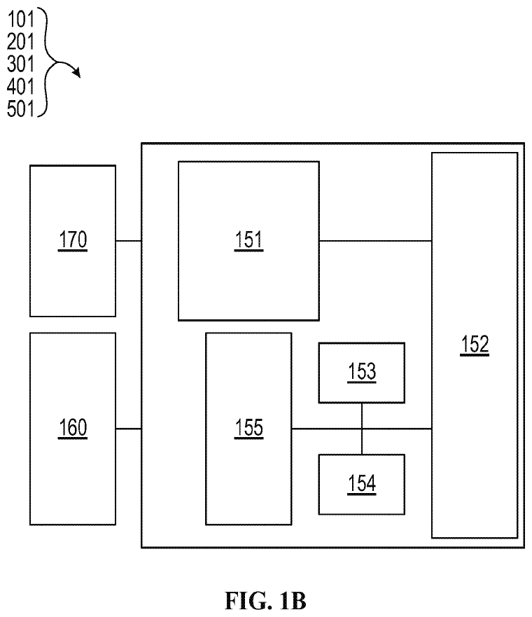

FIG. 2A depicts another illustrative leak emissions sensor system 202 that includes a sensor assembly 201 moveable along a vertical displacement apparatus 232 for detecting an emissions leak from a source, according to one or more embodiments. The sensor assembly 201 can be disposed on or attached to the vertical displacement apparatus 232. In some embodiments, the sensor assembly 201 can be as described with reference to FIG. 1B. In some embodiments, the vertical displacement apparatus 232 can be configured to relocate the sensor assembly 201 within the facility via a vertical conveyance method. The sensor assembly 201 can be disposed on or attached to the vertical displacement apparatus 232 by any appropriate apparatus. In some embodiments, the sensor assembly 201 can be disposed on or attached to the vertical displacement apparatus 232 via gears, adjustable clamps, cables, chains, adhesives, and the like, or any combination thereof. The vertical displacement apparatus 232 can relocate the sensor assembly 201 by any appropriate apparatus in order to change the distance between the ground and the sensor assembly 201 according to instructions from a leak emission computing system (not shown). In some embodiments, the sensor assembly 201 can include one or more wheels or other apparatus that can be configured to move the sensor assembly 201 along the vertical displacement apparatus 232. For example, the sensor assembly 201 can include two or more wheels configured to contact the vertical displacement apparatus 232 and can be operated to move the sensor up and down thereon. In other embodiments, the vertical displacement apparatus 232 can include a moveable surface, e.g., a conveyor belt, that can be operated to move the sensor assembly 201 secured thereto. By relocating the sensor assembly 201 along the vertical displacement apparatus 232, the sensor assembly 201 can detect emission measurements at a plurality of locations. In some embodiments, the vertical displacement apparatus 232 can relocate the sensor assembly 201 from a first vertical position 210 to a second vertical position 215 and back again. In some embodiments, the vertical displacement apparatus 232 can relocate the sensor assembly 201 to a plurality of vertical positions or to any location along the vertical displacement apparatus 232.

FIG. 2B depicts another illustrative leak emissions sensor system 204 that includes the sensor assembly 201 moveable along a rotational displacement apparatus 234 for detecting an emissions leak from a source, according to one or more embodiments. The sensor assembly 201 can be disposed on or attached to the rotational displacement apparatus 234. In some embodiments, the sensor assembly 201 can be as described with reference to FIG. 1B. In some embodiments, the rotational displacement apparatus 234 can be configured to relocate the sensor assembly 201 within the facility in a rotational conveyance method. The sensor assembly 201 can be disposed on or attached to the rotational displacement apparatus 234 by any appropriate means. The rotational displacement apparatus 234 can rotate the sensor assembly 201 by any appropriate means in order to change the relative rotational position of the sensor assembly 201 according to instructions from the leak emission computing system (not shown). In some embodiments, an electric or other powered motor can be operated to cause the rotational displacement apparatus 234 to rotate the sensor assembly 201. In other embodiments, the rotational displacement apparatus 234 can include a sail connected thereto that can utilize wind to move the rotational displacement apparatus 234 such that the sensor assembly 201 can be rotationally moved about the rotational displacement apparatus 234 to a downwind location. By rotating the sensor assembly 201 along the rotational displacement apparatus 234, the sensor assembly 201 can detect emission measurements at a plurality of locations. In some embodiments, the rotational displacement apparatus 234 can rotate the sensor assembly 201 to a plurality of rotational positions or to any location along the rotational displacement apparatus 234.

Although not shown, a person skilled in the art would readily understand that the sensor assembly 234 can be configured to move both vertically and rotationally about the vertical displacement apparatus 232. For example, the sensor assembly 234 can be coupled to a rotational displacement apparatus 234 that can be coupled to the vertical displacement apparatus 232 such that the sensor assembly 201 can move up and down and around the vertical displacement apparats 232.

FIG. 2C depicts another illustrative leak emissions sensor system 206 that includes the sensor assembly 201 moveable along a railway displacement apparatus 236 for detecting an emissions leak from a source, according to one or more embodiments. The sensor assembly 201 can be disposed upon or attached to the railway displacement apparatus 236. In some embodiments, the sensor assembly 201 can be as described with reference to FIG. 1B. In some embodiments, the railway displacement apparatus 236 can be configured to relocate the sensor assembly 201 within the facility along a rail, track, or similar conveyance method. The sensor assembly 201 can be disposed on or attached to the railway displacement apparatus 236 by any appropriate means. The railway displacement apparatus 236 can relocate the sensor assembly 201 by any appropriate means in order to change the location of the sensor assembly 201 within the facility according to instructions from the leak emission computing system (not shown). By relocating the sensor assembly 201 along the railway displacement apparatus 236, the sensor assembly 201 can detect emission measurements at a plurality of locations. In some embodiments, the vertical displacement apparatus 236 can relocate the sensor assembly 201 from a first railway position 210 to a second railway position 215 and back again. In some embodiments, the railway displacement apparatus 236 can relocate the sensor assembly 201 to a plurality of railway positions or to any location along the railway displacement apparatus 232.

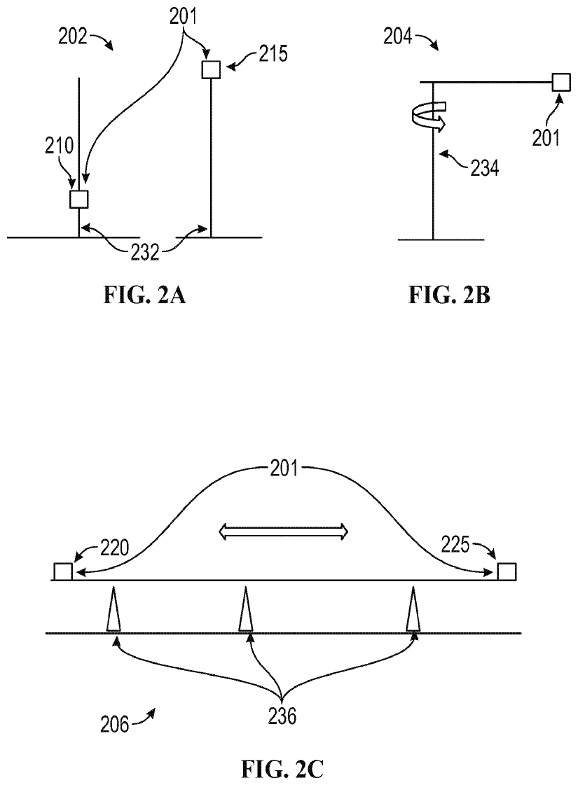

FIG. 3 depicts another illustrative leak emissions sensor system 300 that includes a sensor-pump assembly 301 and one or more airflow apparatus 302 for detecting a gas plume from an emissions source, according to one or more embodiments. In some embodiments, the sensor-pump assembly 301 can include the pump 160 as described with reference to FIG. 1B. The sensor-pump assembly 301 can be located within the facility or can be located elsewhere, e.g., outside the facility. The sensor-pump assembly 301 can include a sensor assembly 101 and the pump 160 as described above with reference to FIGS. 1A and 1B. The pump 160 can be any suitable pump designed to move air and/or gaseous fluids.

In some embodiments, the airflow apparatus 302 can include one or more holes 303 configured to allow outside air and/or gaseous fluids to enter the airflow apparatus 302. In some embodiments, the sensor-pump assembly 301 can be in fluid communication with the airflow apparatus 302. In some embodiments, the sensor-pump assembly 301 can use the pump to draw outside air and/or gaseous fluids through the holes 303 and into the airflow apparatus 302 in order for the sensor assembly 101 to create come into contact with the outside air and/or gaseous fluids to obtain emission information. In some embodiments, the holes 303 can vary in size along the airflow apparatus 302 to ensure an equal or substantially equal weighting of the gas intake from all the holes 303, which can depend, at least in part, on an inner diameter or average cross-sectional length of the airflow apparatus 302, length of the airflow apparatus 302, and/or a flowrate of the gas within the airflow apparatus 302.

In some embodiments, a control valve can be in fluid communication with an inlet of each airflow apparatus 302. Such valves can be configured to be opened and closed upon detection of an emissions leak that can facilitate narrowing down the area from which the emissions leak originates within the facility. For example, as shown in FIG. 3, there can be two airflow apparatus 302 tubes spread out over two angular sectors. In another example, there could be four tubes covering four different sectors, and so forth. An alternative implementation could include having a valve on each hole in the airflow apparatus 302 for further increased spatial resolution.

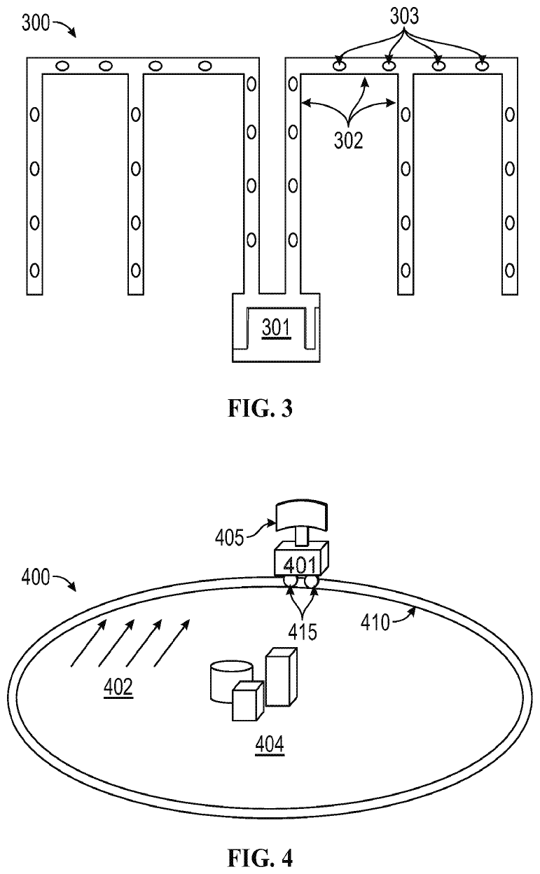

FIG. 4 depicts another illustrative leak emissions sensor system 400 that includes a movable sensor assembly 401, a sail 405, and a railway sensor track 410 for detecting a gas plume from a source 404, according to one or more embodiments described. In some embodiments, the sensor assembly 401 can be as described above with reference to FIG. 1B. A plurality of railway wheels 415 can be attached to and/or disposed upon the movable sensor assembly. The movable sensor assembly 401 can be attached to and/or disposed upon the railway sensor track 410 using the plurality of railway wheels 415. In some embodiments, the railway sensor track 410 can be configured to allow the movable sensor assembly 401 to freely move along the railway sensor track 410. In some embodiments, the railway sensor track 410 can be a continuous circular, oval, or other appropriate shape sufficient to circumscribe some or all of the facility. The sail 405 can be attached to and/or disposed upon the movable sensor assembly 401. In some embodiments, the sail 405 can be configured to utilize a wind direction 402 to freely move the movable sensor assembly 401 along the railway sensor track 410 in order to locate and/or orient the movable sensor assembly 401 with regards to the wind direction 402. In other words, the sail 405 can utilize the wind direction 402 to passively locate the sensor assembly 401 in a downwind location.

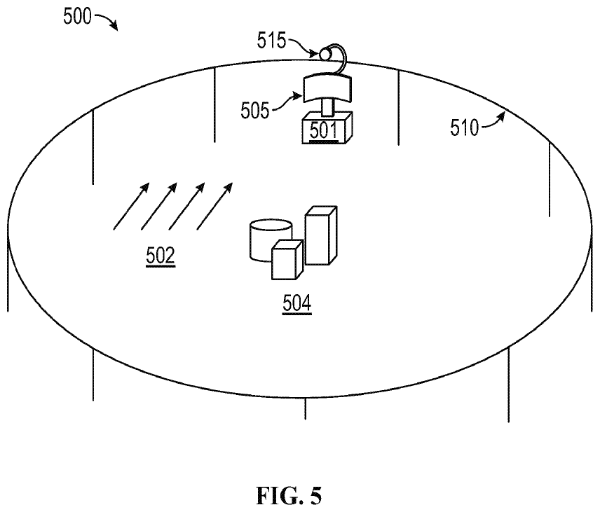

FIG. 5 depicts another illustrative leak emissions sensor system 500 that includes a movable sensor assembly 501, a sail 505, and a cable-car sensor track 510 for detecting a gas plume from a source 504, according to one or more embodiments. In some embodiments, the sensor assembly 501 can be as described above with reference to FIG. 1B. At least one cable-car wheel 515 can be attached to and/or disposed on the movable sensor assembly 501. The movable sensor assembly 501 can be attached to and/or disposed on the cable-car sensor track 510 using the at least one cable-car wheel 515. In some embodiments, the cable-car sensor track 510 can be configured to allow the movable sensor assembly 501 to freely move along the cable-car sensor track 510. In some embodiments, the cable-car sensor track 510 can be a continuous circular, oval, or other appropriate shape sufficient to circumscribe some or all of the facility. The sail 505 can be attached to and/or disposed on the movable sensor assembly 501. In some embodiments, the sail 505 can be configured to utilize a wind direction 502 to freely move the movable sensor assembly 501 along the cable-car sensor track 510 in order to locate and/or orient the movable sensor assembly 501 with regards to the wind direction 502. In other words, the sail 505 can utilize the wind direction 502 to passively locate the moveable sensor assembly 501 in a downwind location.

Another implementation of the mobile sensor assembly can be to utilize an airborne vehicle such as a remote-controlled or autonomous drone, glider or blimp with a sensor assembly mounted thereon. The vehicle, e.g., drone, could be battery operated with a docking base station placed somewhere within the facility or well pad. The docking base station could be supplied with a battery that could be charged with a solar kit. The drone can be configured to charge its battery at the loading dock between flights. The flight route could be optimized for the given facility and given vehicle flight envelope. Upon detection at a particular location in space, the route could be modified in real-time to zero-in on a likely emissions leak source location based on the prevailing wind measurement and a plume dispersion model. Subsequent routes, after recharging at the base station, could be modified as well to monitor the most likely emissions leak source location. Smart inversion algorithms, utilizing plume dispersion forward models and other atmospheric data inputs can be used for intelligent leak rate and location estimation to guide future drone routes. An alternative to a battery-operated drone could be a tethered drone or blimp that can be permanently connected with a cable to the docking station that can allow it to hover over a facility to take measurements over an extended period-of-time to aid data generation for emissions leak source determination.

It should be understood that the sensor assemblies 101, 201, 301, 401, and/or 501 can be configured to obtain emission information while in a fixed position and/or while moving. It should also be understood that data from two or more of the sensor assemblies 101, 201, 301, 401, and/or 501 can be combined to provide a greater number of data points with regard to the emission information obtained by a plurality of sensor assemblies.

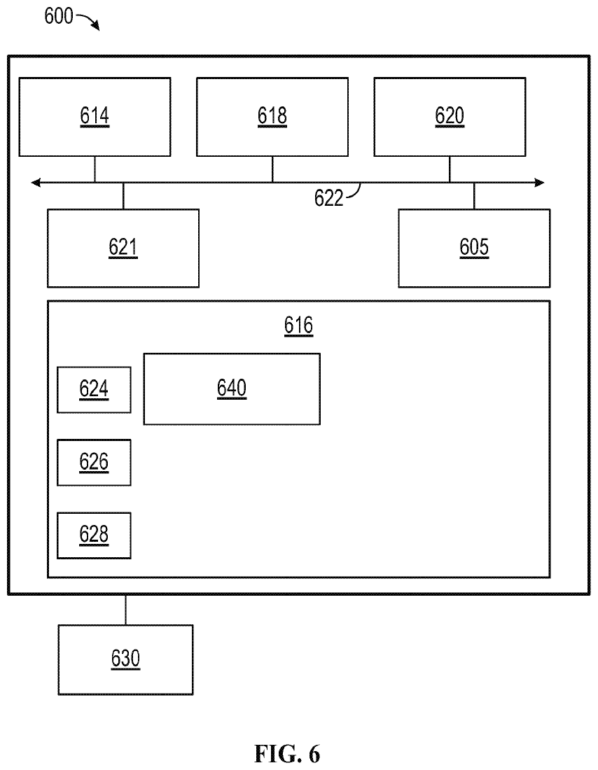

FIG. 6 depicts a schematic of an illustrative leak emission computing system 600 for automating conveyance operations using a displacement apparatus, according to one or more embodiments. The computer system 612 can be located within the facility or can be located elsewhere. One or more chips, for example chips 605 and/or 621, can be or can include field-programmable gate arrays (“FPGAs”), application specific integrated circuits (“ASICs”), chiplets, Multi-Chip-Modules, central processing units (“CPUs”), and/or system-on-chips (“SOCs”), to name a few. The chip can be used in a wide-range of applications, including but not limited to auto emission detection, environmental monitoring, or other digital processing systems. The ASICs can include entire microprocessors, memory blocks including read only memory (ROM), random access memory (RAM), erasable programmable read only memory (EPROM), electrically erasable programmable read only memory (EEPROM), flash memory and other building blocks and can be known as system-on-chip (“SoC”).

To achieve its desired functionality, the computing system 600 can include various hardware and software components. Among these components can be one or more processors 614 and a command actuator 640. These hardware components can be interconnected through the use of a number of electrical connections, busses, and/or network connections. In one embodiment, the processor 614, the chip 605, the chip 621, and the command actuator 640 can be communicatively coupled via a bus 622. The bus 622 can be or include any know computing system bus. The command actuator 640 can be internal to a data storage device 616.

The chip 605, the chip 621, and/or the command actuator 640 can include, either separately or in some combination, software and hardware, including tangible, non-transitory computer readable medium (not shown), for estimating the location for one or more emission regions 105 within the facility, as shown in FIG. 1. In some embodiments, smart inversion algorithms or techniques that can utilize plume dispersion forward models and other atmospheric data inputs can be used to estimate the location of one or more emission regions 105. The command actuator 640 can be integrated into the chip 605, the chip 621, and/or the processor 614. The chip 605 and/or the chip 621 can be integrated into the processor 614. Although command actuator 640 is depicted as being internal to the data storage device 616, in other examples, the command actuator 640 can be a peripheral device (not shown) coupled to the computing system 612 or included within a peripheral device (not shown) coupled to the computing system 612.

The command actuator 640 can include instructions that when executed by the command actuator 640 can cause the command actuator 640 to implement at least the functionality of receiving emission information through a network adapter, processing the emission information from the sensor assembly through the processor according to the instructions stored in the memory to create a command, and relocating the sensor assembly and for determining the location of a leak emission according to the command. In some embodiments, the instructions can, when executed by the command actuator 640, cause the command actuator 640 to use one or more inversion procedures or techniques to determine a location of one or more emission events using the emission information received. In some embodiments, the instructions can, when executed by the command actuator 640, cause the command actuator 640 to use optimization-based analyses to infer the one or more emission events using the one or more inference models.

In one or more embodiments, the command actuator 640 can work in conjunction with the processor 614 to implement the functionality described above. In some embodiments, the command actuator 640 can execute firmware code stored on the computing system 600, such as on the chip 605, the chip 621, and/or the processor 614. The functionality of the computing system 600 and/or the command actuator 640 can be in accordance with the processes of the present specification described herein. In the course of executing code, the processor 614 and/or the command actuator 640 can receive input from and provide output to a number of the remaining hardware units.

The computing system 600 can be implemented in an electronic device. Examples of electronic devices include servers, desktop computers, laptop computers, cloud-based computers, personal digital assistants (“PDAs”), mobile devices, smartphones, gaming systems, and tablets, among other electronic devices. The computing system 600 can be utilized in any data processing scenario including, stand-alone hardware, mobile applications, through a computing network, or combinations thereof. Further, the computing system 600 can be used in a computing network, a public cloud network, a private cloud network, a hybrid cloud network, other forms of networks, or combinations thereof. In one example, the processes provided by the computing system 600 can be provided as a service by a third party.

To achieve its desired functionality, the computing system 600 can include various other hardware components. Among these other hardware components can be a number of data storage devices or tangible, non-transitory computer readable medium 616, a number of peripheral device adapters 618, and a number of network adapters 620. These hardware components can be interconnected through the use of a number of electrical connections, busses, and/or network connections.

The chip 605, the chip 621, and/or the processor 614 can include the hardware and/or firmware/software architecture to retrieve executable code from the data storage device 616 and execute the executable code. The executable code can, when executed by the chip 605, the chip 621, and/or the processor 614, cause the chip 605, the chip 621, and/or the processor 614 to implement at least the functionality of receiving emission information through a network adapter, processing the emission information from the sensor assembly through the processor according to the instructions stored in the memory to create a command, and relocating the sensor assembly and for determining the location of a leak emission according to the command.

The data storage device 616 can store data such as executable program code that is executed by the processor 614, the command actuator 640, or other processing devices. The processor 614 can be a central processing unit that is to execute an operating system in the computing system 600. As will be discussed, the data storage device 616 can specifically store computer code representing a number of applications that the processor 614 and/or the command actuator 640 can execute to implement at least the functionality described herein.

In one or more embodiments, the data storage device 616 can include various types of memory modules, including volatile and nonvolatile memory. In one or more embodiments, the data storage device 616 of the present example can include Random Access Memory (“RAM”) 624, Read Only Memory (“ROM”) 626, and Hard Disk Drive (“HDD”) storage 628. Many other types of memory can also be utilized, and the present specification contemplates the use of many varying type(s) of memory in the data storage device 616 as can suit a particular application of the principles described herein. In certain examples, different types of memory in the data storage device 616 can be used for different data storage requirements. In one or more embodiments, in certain examples the processor 614 can boot from Read Only Memory (“ROM”) 626, maintain nonvolatile storage in the Hard Disk Drive (“HDD”) memory 628, and execute program code stored in Random Access Memory (“RAM”) 624. In examples, the chip 605, and the chip 621 can boot from the Read Only Memory (“ROM”) 626.

The data storage device 616 can include a computer readable medium, a computer readable storage medium, or a non-transitory computer readable medium, among others. In one or more embodiments, the data storage device 616 can be, an electronic, magnetic, optical, electromagnetic, infrared, or semiconductor system, apparatus, or device, or any suitable combination of the foregoing. More specific examples of the computer readable storage medium can include, for example, the following: an electrical connection having a number of wires, a portable computer diskette, a hard disk, a RAM, a ROM, an EPROM, a Flash memory, a portable compact disc read only memory (“CD-ROM”), an optical storage device, a magnetic storage device, or any suitable combination of the foregoing. In the context of this document, a computer readable storage medium can be any tangible medium that can contain, or store computer usable program code for use by or in connection with an instruction execution system, apparatus, or device. In another example, a computer readable storage medium can be any non-transitory medium that can contain or store a program for use by or in connection with an instruction execution system, apparatus, or device.

The hardware adapters 618, 620 in the computing system 600 can enable the processor 614 to interface with various other hardware elements, external and internal to the computing system 600. In one or more embodiments, the peripheral device adapters 618 can provide an interface to input/output devices, such as, for example, a display device 630, a mouse, and/or a keyboard. The peripheral device adapters 618 can also provide access to other external devices such as an external storage device, a number of network devices such as, for example, servers, switches, and routers, client devices, other types of computing devices, and combinations thereof.

The display device 630 can be provided to allow a user of the computing system 600 to interact with and implement the functionality of the computing system 600. Examples of display devices 630 can include a computer screen, a laptop screen, a mobile device screen, a personal digital assistant (“PDA”) screen, and/or a tablet screen, among other display devices 630.

The peripheral device adapters 618 can also create an interface between the processor 614 and the display device 630, a printer, or other media output devices. The network adapter 620 can provide an interface to other computing devices within, for example, a network, thereby enabling the transmission of data between the computing system 600 and other devices located within the network. The network adapter 620 can provide an interface to an external telecommunications network such as a cellular phone network or other radio frequency enabled network, thereby enabling the transmission of data between the computing system 600 and other external devices such as an external storage device, a number of network devices such as, for example, servers, switches, and routers, client servers, radio frequency enabled devices, other client devices, other types of computing devices, and combinations thereof.

The computing system 600 can further include a number of modules used in the implementation of the process and systems described herein. The various modules within the computing system 600 can include executable program code that can be executed separately. In this example, the various modules can be stored as separate computer program products. In another example, the various modules within the computing system 600 can be combined within a number of computer program products; each computer program product including a number of the modules.

All patents and patent applications, test procedures (such as ASTM methods, UL methods, and the like), and other documents cited herein are fully incorporated by reference to the extent such disclosure can be not inconsistent with this disclosure and for all jurisdictions in which such incorporation can be permitted.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

The foregoing has also outlined features of several embodiments so that those skilled in the art can better understand the present disclosure. Those skilled in the art should appreciate that they can readily use the present disclosure as a basis for designing or modifying other methods or devices for carrying out the same purposes and/or achieving the same advantages of the embodiments disclosed herein. Those skilled in the art should also realize that such equivalent constructions do not depart from the spirit and scope of the present disclosure, and that they can make various changes, substitutions, and alterations herein without departing from the spirit and scope of the present disclosure, and the scope thereof can be determined by the claims that follow.

1. A leak emissions sensor system for a facility, comprising one or more detector assemblies, each detector assembly comprising:
a sensor assembly for obtaining and sending emission information, wherein:
the sensor assembly comprises a leak emission detection sensor, a sensor processor, a GPS, a real-time clock, a wind sensor, and a sensor communicator; and
a displacement apparatus, wherein:
the sensor assembly is disposed on the displacement apparatus, and
the displacement apparatus is configured to relocate the sensor assembly within the facility.

2. The leak emissions sensor system of claim 1, wherein the leak emissions sensor system further comprises a leak emission computing system, comprising:
a network adapter for receiving the emission information from the sensor communicator;
a memory for storing the emission information and instructions;
a processor for processing the emission information according to the instructions stored in the memory to create a command; and
a command actuator for relocating the sensor assembly.

3. The leak emission sensor system of claim 2, wherein the leak emission computing system is configured to process data received from the one or more detector assemblies.

4. The leak emissions sensor system according to claim 1, wherein the displacement apparatus is configured to relocate the sensor assembly along a vertical axis with respect to a position of the sensor assembly along the displacement apparatus.

5. The leak emissions sensor system according to claim 1, wherein the displacement apparatus is configured to relocate the sensor assembly with respect to a rotational position of the sensor assembly about the displacement apparatus.

6. The leak emissions sensor system according to claim 1, wherein the displacement apparatus is configured to relocate the sensor assembly along a horizontal axis with respect to a position of the sensor assembly along the displacement apparatus.

7. A leak emissions sensor system for a facility, comprising one or more detector assemblies, each detector assembly comprising:
a sensor assembly for obtaining and sending emission information, wherein:
the sensor assembly includes a leak emission detection sensor, a sensor processor, a GPS, a real-time clock, a wind sensor, a pump, and a sensor communicator; and
an airflow apparatus, wherein:
the sensor assembly is in fluid communication within the airflow apparatus, and
the airflow apparatus is configured to direct a gas to or about the sensor assembly using the pump.

8. The leak emissions sensor system according to claim 7, wherein the leak emissions sensor system includes a leak emission computing system, comprising:
a network adapter for receiving the emission information from the sensor communicator;
a memory for storing the emission information and instructions;
a processor for processing the emission information according to the instructions stored in the memory to create a command; and
a command actuator for operating the pump.

9. The leak emission sensor system of claim 8, wherein the leak emission computing system is configured to process data received from the one or more detector assemblies.

10. The leak emissions sensor system according to claim 7, wherein the airflow apparatus comprises one or more tubes, and wherein the one or more tubes comprise a plurality of holes disposed along a length thereof configured to allow the gas to flow into the airflow apparatus.

11. The leak emissions sensor system according to claim 7, wherein the airflow apparatus is configured to direct the gas from nearly the entire facility.

12. A leak emissions sensor system for a facility, comprising one or more detector assemblies, the detector assembly comprising:
a sensor assembly for obtaining and sending emission information, wherein:
the sensor assembly includes a leak emission detection sensor, a sensor processor, a GPS, a real-time clock, a wind sensor, and a sensor communicator;
a sensor track; and
a sail, wherein:
the sensor assembly is disposed on the sensor track,
the sensor track is configured to allow the sensor assembly to freely move along the sensor track,
the sail is disposed on the sensor assembly, and
the sail is configured to utilize air movement about the sensor assembly to move the sensor assembly along the sensor track.

13. The leak emissions sensor system according to claim 12, wherein the leak emissions sensor system includes a leak emission computing system, comprising:
a network adapter for receiving the emission information from the sensor communicator;
a memory for storing the emission information and instructions; and
a processor for processing the emission information according to the instructions stored in the memory.

14. The leak emission sensor system of claim 13, wherein the leak emission computing system is configured to process data received from the one or more detector assemblies.

15. The leak emissions sensor system according to claim 12, wherein the sensor track is a railway configuration.

16. The leak emissions sensor system according to claim 12, wherein the sensor track is a cable-car configuration.

17. The leak emissions sensor system according to claim 12, wherein the sail is configured to move the sensor assembly in a downwind direction.
